(19) United States
(12) Patent Application Publication
(10) Pub. No.: US 2014/0273992 A1
(43) Pub. Date: Sep. 18, 2014

(54) REAL-TIME TRANSMISSION OF PHYSICAL REPRESENTATIONS FROM ONE LOCATION TO ANOTHER LOCATION

(71) Applicant: Avocado Software, Inc., San Francisco, CA (US)

(72) Inventors: Christopher WETHERELL, San Francisco, CA (US); Rizwan SATTAR, Aliso Viejo, CA (US)

(21) Appl. No.: 13/841,001

(22) Filed: Mar. 15, 2013

(51) Int. Cl. H04W 4/16

(52) U.S. Cl. CPC H04W 4/16
USPC 455/414.1

(57) ABSTRACT

A system and a method are disclosed for transmitting a physical representation from one location to another location. Components included in a mobile computing device can be used to detect that a physical action has been performed, and to simulate physical representations. In one embodiment, a first user sends a physical representation using a mobile computing device. The user receiving the physical representation is asked to perform a physical action. The second user's mobile computing device then detects that the physical action has been performed and simulates the physical representation the first user sent.

### BACKGROUND

1. Field of Art

The disclosure generally relates to the field of mobile computing devices, and more particularly, to transmission of non-verbal communications using a mobile computing device.

2. Description of Art

Mobile computing devices (e.g. smartphones or tablets) include components that can be used to provide haptic feedback. For example, vibrations can be used to simulate pressing a key in a virtual keyboard on a smartphone's screen. Additionally, mobile computing devices also include a number of sensors that can be used to detect physical quantities and trigger a response from the mobile computing device. For example a gyroscope can be used to detect the orientation of the mobile computing device and rotate the display accordingly.

The main function of certain mobile computing devices such as a smartphones is to provide a communication channel between two people. One problem of mobile computing devices is that it only enables the transmission of verbal communications. Mobile computing devices are not used for non-verbal communications. Using the sensors and haptic feedback components, physical representations can be sent from one location to another location enabling the transmission of non-verbal communications.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1A illustrates one embodiment of a mobile computing device in a first positional state.

FIG. 1B illustrates one embodiment of the mobile computing device in a second positional state.

FIG. 2 illustrates one embodiment of an architecture of a mobile computing device.

FIG. 3A illustrates one embodiment of the sensing module.

FIG. 3B illustrates one embodiment of the physical representation transmission module.

FIGS. 4A and 4B illustrate flowcharts for the transmission of physical representations from one location to another location.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of a disclosed system, method and computer readable storage medium includes transmitting a physical representation from one location to another location. As used herein, a physical representation is defined as a type of non-verbal communication that can be enacted at one location and transmitted for reciprocal receipt at a second location relatively contemporaneous in time. The enacted action may be transmitted through haptic mechanisms. Illustratively, a physical representation can take the form of a hug, kiss, punch, or other physical enactment that would otherwise be between two or more individuals.

In one embodiment, a user of a first mobile computing device sends a physical representation, such as a hug, to a user of a second mobile computing device. The representation is embodied within a signal that may include additional instructions, for example, the receiving mobile computing device receives the signal, which may include instructions to perform a physical action, such as hugging the second mobile device. The second mobile computing device can wait for the user to perform the action. When the second mobile computing device determines that the physical action has been performed, the second device simulates the physical representation that the first user is trying to send. In some embodiments, the first mobile computing device may also ask the first user to perform the physical action and upon detecting that the physical action has been performed, it also simulates the physical representation.

### Example Mobile Computing Device

In one example embodiment, the configuration as disclosed may be configured for use between a mobile computing device, that may be host device, and an accessory device. FIGS. 1a and 1b illustrate one embodiment of a mobile computing device 110. Figure (FIG. 1a illustrates one embodiment of a first positional state of the mobile computing device 110 having telephonic functionality, e.g., a mobile phone or smartphone. FIG. 1b illustrates one embodiment of an optional second positional state of the mobile computing device 110 having telephonic functionality, e.g., a mobile phone, smartphone, tablet, netbook, or laptop computer. The mobile computing device 110 is configured to host and execute a phone application for placing and receiving telephone calls.

It is noted that for ease of understanding the principles disclosed herein are in an example context of a mobile computing device 110 with telephonic functionality operating in a mobile telecommunications network. However, the principles disclosed herein may be applied in other duplex (or multiplex) telephonic contexts such as devices with telephonic functionality configured to directly interface with public switched telephone networks (PSTN) and/or data networks having voice over internet protocol (VoIP) functionality. Likewise, the mobile computing device 110 is only by way of example, and the principles of its functionality apply to other computing devices, e.g., desktop computers, server computers and the like.

The mobile computing device 110 includes a first portion 110a and a second portion 110b. The first portion 110a comprises a screen for display of information (or data) and may include navigational mechanisms. These aspects of the first portion 110a are further described below. The second portion 110b comprises a keyboard and also is further described below. The first positional state of the mobile computing device 110 may be referred to as an “open” position, in which the first portion 110a of the mobile computing device slides in a first direction exposing the second portion 110b of the mobile computing device 110 (or vice versa in terms of movement). The mobile computing device 110 remains operational in either the first positional state or the second positional state.

The mobile computing device 110 is configured to be of a form factor that is convenient to hold in a user's hand, for example, a personal digital assistant (PDA) or a smart phone form factor. For example, the mobile computing device 110 can have dimensions ranging from 7.5 to 15.5 centimeters in length, 5 to 15 centimeters in width, 0.5 to 2.5 centimeters in thickness and weigh between 50 and 250 grams.

The mobile computing device 110 includes a speaker 120, a screen 130, and an optional navigation area 140 as shown in the first positional state. The mobile computing device 110 also includes a keypad 150, which is exposed in the second positional state. The mobile computing device also includes a microphone (not shown). The mobile computing device 110 also may include one or more switches (not shown). The one or more switches may be buttons, sliders, or rocker switches and can be mechanical or solid state (e.g., touch sensitive solid state switch).

The screen 130 of the mobile computing device 110 is, for example, a 240×240, a 370×370, a 370×480, or a 640×480 touch sensitive (including gestures) display screen. The screen 130 can be structured from, for example, glass, plastic, thin-film or composite material. The touch sensitive screen may be a transflective liquid crystal display (LCD) screen. In alternative embodiments, the aspect ratios and resolution may be different without departing from the principles of the inventive features disclosed within the description. By way of example, embodiments of the screen 130 comprises an active matrix liquid crystal display (AMLCD), a thin-film transistor liquid crystal display (TFT-LCD), an organic light emitting diode (OLED), an interferometric modulator display (IMOD), a liquid crystal display (LCD), or other suitable display device. In an embodiment, the display displays color images. In another embodiment, the screen 130 further comprises a touch-sensitive display (e.g., pressure-sensitive (resistive), electrically sensitive (capacitive), acoustically sensitive (SAW or surface acoustic wave), photo-sensitive (infra-red)) including a digitizer for receiving input data, commands or information from a user. The user may use a stylus, a finger or another suitable input device for data entry, such as selecting from a menu or entering text data.

The optional navigation area 140 is configured to control functions of an application executing in the mobile computing device 110 and visible through the screen 130. For example, the navigation area includes an x-way (x is a numerical integer, e.g., 5) navigation ring that provides cursor control, selection, and similar functionality. In addition, the navigation area may include selection buttons to select functions displayed through a user interface on the screen 130. In addition, the navigation area also may include dedicated function buttons for functions such as, for example, a calendar, a web browser, an e-mail client or a home screen. In this example, the navigation ring may be implemented through mechanical, solid state switches, dials, or a combination thereof. In an alternate embodiment, the navigation area 140 may be configured as a dedicated gesture area, which allows for gesture interaction and control of functions and operations shown through a user interface displayed on the screen 130.

The keypad area 150 may be a numeric keypad (e.g., a dialpad) or a numeric keypad integrated with an alpha or alphanumeric keypad or character keypad 150 (e.g., a keyboard with consecutive keys of Q-W-E-R-T-Y, A-Z-E-R-T-Y, or other equivalent set of keys on a keyboard such as a DVORAK keyboard or a double-byte character keyboard).

Although not illustrated, it is noted that the mobile computing device 110 also may include an expansion slot. The expansion slot is configured to receive and support expansion cards (or media cards). Examples of memory or media card form factors include COMPACTFLASH, SD CARD, XD CARD, MEMORY STICK, MULTIMEDIA CARD, SDIO, and the like.

### Example Mobile Computing Device Architectural Overview

Referring next to FIG. 2, a block diagram illustrates one embodiment of an architecture of a mobile computing device 110, with telephonic functionality. By way of example, the architecture illustrated in FIG. 2 will be described with respect to the mobile computing device 110 of FIGS. 1a and 1b. The mobile computing device 110 includes a central processor 220, a power supply 240, and a radio subsystem 250. Examples of a central processor 220 include processing chips and system based on architectures such as ARM (including cores made by microprocessor manufacturers), ARM XSCALE, AMD ATHLON, SEMPRON or PHENOM, INTEL ATOM, XSCALE, CELERON, CORE, PENTIUM or ITANIUM, IBM CELL, POWER ARCHITECTURE, SUN SPARC and the like.

The central processor 220 is configured for operation with a computer operating system. The operating system is an interface between hardware and an application, with which a user typically interfaces. The operating system is responsible for the management and coordination of activities and the sharing of resources of the mobile computing device 110. The operating system provides a host environment for applications that are run on the mobile computing device 110. As a host, one of the purposes of an operating system is to handle the details of the operation of the mobile computing device 110. Examples of an operating system include MICROSOFT WINDOWS (including WINDOWS 8, and WINDOWS PHONE), SYMBIAN OS, RIM BLACKBERRY OS, APPLE OS (including MAC OS and IOS), GOOGLE ANDROID, and LINUX.

The central processor 220 communicates with an audio system 210, an image capture subsystem (e.g., camera, video or scanner) 212, flash memory 214, RAM memory 216, and a short range radio module 218 (e.g., Bluetooth, Wireless Fidelity (WiFi) component (e.g., IEEE 802.11)). The central processor communicatively couples these various components or modules through a data line (or bus) 278. The power supply 240 powers the central processor 220, the radio subsystem 250 and a display driver 230 (which may be contact- or inductive-sensitive). The power supply 240 may correspond to a direct current source (e.g., a battery pack, including rechargeable) or an alternating current (AC) source. The power supply 240 powers the various components through a power line (or bus) 279.

The central processor communicates with applications executing within the mobile computing device 110 through the operating system 220a. In addition, intermediary components, for example, a window manager module 222 and a screen manager module 226, provide additional communication channels between the central processor 220 and operating system 220 and system components, for example, the display driver 230.

In one embodiment, the window manager module 222 comprises a software (e.g., integrated with the operating system) or firmware (lower level code that resides is a specific memory for that code and for interfacing with specific hardware, e.g., the processor 220). The window manager module 222 is configured to initialize a virtual display space, which may be stored in the RAM 216 and/or the flash memory 214. The virtual display space includes one or more applications currently being executed by a user and the current status of the executed applications. The window manager module 222 receives requests, from user input or from software or firmware processes, to show a window and determines the initial position of the requested window. Additionally, the window manager module 222 receives commands or instructions to modify a window, such as resizing the window, moving the window or any other command altering the appearance or position of the window, and modifies the window accordingly.

The screen manager module 226 comprises a software (e.g., integrated with the operating system) or firmware. The screen manager module 226 is configured to manage content that will be displayed on the screen 130. In one embodiment, the screen manager module 226 monitors and controls the physical location of data displayed on the screen 130 and which data is displayed on the screen 130. The screen manager module 226 alters or updates the location of data as viewed on the screen 130. The alteration or update is responsive to input from the central processor 220 and display driver 230, which modifies appearances displayed on the screen 130. In one embodiment, the screen manager 226 also is configured to monitor and control screen brightness. In addition, the screen manager 226 is configured to transmit control signals to the central processor 220 to modify power usage of the screen 130.

A physical representation transmission module 228 comprises software that is, for example, integrated with the operating system or configured to be an application operational with the operating system. In some embodiments it may comprise firmware, for example, stored in the flash memory 214. The physical representation transmission module 228 is configured to transmit physical representations from one location to another location. In one embodiment, the physical representation transmission module 228 is configured to transmit a hug or a handshake from one mobile computing device 110 to another mobile computing device 110. In other embodiments, the physical representation transmission module 228 may be configured to transmit other types of physical representations such as a kiss or a hand slap (e.g. a “high five”).

In one embodiment, if multiple physical representations can be transmitted, the physical representation transmission module 228 asks the user to select a physical representation from a list of pre-configured physical representations (e.g. a list of two or more physical representations). In another embodiment, if the physical representation transmission module 228 is only configured to transmit one type of physical representation, the physical representation transmission module 228 starts the physical representation transmission process without the user having to select a type of physical representation, e.g. a default physical representation being pre-selected or assigned. In yet another embodiment, the physical representation transmission module allows the user to customize his own physical representation and specify the types of actions the physical representation transmission module 228 needs to perform in order to complete the physical representation transmission process.

It is noted that in one embodiment, central processor 220 executes logic (e.g., by way of programming, code, or instructions) corresponding to executing applications interfaced through, for example, the navigation area 140 or switches 170. It is noted that numerous other components and variations are possible to the hardware architecture of the computing device 200, thus an embodiment such as shown by FIG. 2 is just illustrative of one implementation for an embodiment.

The radio subsystem 250 includes a radio processor 260, a radio memory 262, and a transceiver 264. The transceiver 264 may be two separate components for transmitting and receiving signals or a single component for both transmitting and receiving signals. In either instance, it is referenced as a transceiver 264. The receiver portion of the transceiver 264 communicatively couples with a radio signal input of the device 110, e.g., an antenna, where communication signals are received from an established call (e.g., a connected or on-going call). The received communication signals include voice (or other sound signals) received from the call and processed by the radio processor 260 for output through the speaker 120 (or 184). The transmitter portion of the transceiver 264 communicatively couples a radio signal output of the device 110, e.g., the antenna, where communication signals are transmitted to an established (e.g., a connected (or coupled) or active) call. The communication signals for transmission include voice, e.g., received through the microphone 160 of the device 110, (or other sound signals) that is processed by the radio processor 260 for transmission through the transmitter of the transceiver 264 to the established call.

In one embodiment, communications using the described radio communications may be over a voice or data network. Examples of voice networks include Global System of Mobile (GSM) communication system, a Code Division, Multiple Access (CDMA system), and a Universal Mobile Telecommunications System (UMTS). Examples of data networks include General Packet Radio Service (GPRS), third-generation (3G) mobile (or greater), Long Term Evolution (LTE), High Speed Download Packet Access (HSDPA), High Speed Uplink Packet Access (HSUPA), and Worldwide Interoperability for Microwave Access (WiMAX).

While other components may be provided with the radio subsystem 250, the basic components shown provide the ability for the mobile computing device to perform radio-frequency communications, including telephonic communications. In an embodiment, many, if not all, of the components under the control of the central processor 220 are not required by the radio subsystem 250 when a telephone call is established, e.g., connected or ongoing. The radio processor 260 may communicate with central processor 220 using the data line (or bus) 278.

The card interface 224 is adapted to communicate, wirelessly or wired, with external accessories (or peripherals), for example, media cards inserted into the expansion slot (not shown). The card interface 224 transmits data and/or instructions between the central processor and an accessory, e.g., an expansion card or media card, coupled within the expansion slot. The card interface 224 also transmits control signals from the central processor 220 to the expansion slot to configure the accessory. It is noted that the card interface 224 is described with respect to an expansion card or media card; it also may be structurally configured to couple with other types of external devices for the device 110, for example, an inductive charging station for the power supply 240 or a printing device.

The vibration motor 206 is adapted to provide a vibrating motion to the mobile computing device 110. The vibrating motor 206 is commonly comprised of an electric motor and an unbalanced weight. When the electric motor spins the unbalanced weights, since the center of mass of the weights is not located at the center of rotation, the motor starts to shake. The vibration motor 206 is mainly used to provide vibrating alerts, which is used to supplement or substitute an audible alert, such as a ring tone or a text message notification.

The sensing module 208 contains elements to detect or measure a physical quantity and convert it into a signal that can be read by the mobile computing device 110. The sensing module 208 includes a proximity sensor 310, an accelerometer 320, a gyroscope 330, and an ambient light sensor 340. In some embodiments, the sensing module 208 may contain additional sensors such as physiological sensors (e.g., measure blood flow, heart rate, body temperature) and/or a micro-electro mechanical system (MEMS) enabled device. These sensors and/or devices can measure different parameters such as blood flow, temperature, pressure modality, etc. to provide a physiological analysis that can be mapped to a response. For example, a high heart rate and increase in body temperature with higher pressure applied may correspond to an excitement hug while lower heart rate and less pressure applied may correspond with a condolence hug.

The proximity sensor 310 is adapted to detect the presence of nearby objects. In some embodiments, the proximity sensor does not require physical contact with the object being sensed. Embodiments of the proximity sensor 310 operate by emitting an electromagnetic field or a beam of electromagnetic radiation, such as infrared radiation, and looking for changes in the field or return signal. Proximity sensors are utilized, for example, to turn off the screen 130 when a large object, such as a head, is detected. This is particularly useful when a phone call is being made in order to reduce the mobile computing device's energy consumption and eliminate the possibility of accidentally pressing a button on the screen 130 when the head of a person making the phone call is touching the screen 130. Some embodiments of the proximity sensor can recognize the size of the object being sensed and/or the distance between the object and the mobile computing device 110. For example, a proximity sensor 310 may be configured to differentiate between small objects, such as a finger, and large objects, such as a head. Embodiments may also be configured or designed to detect certain materials. For instance an inductive sensor may only detect metallic objects.

The accelerometer 320 is configured to measure the acceleration that the mobile computing device 110 is experiencing. Some embodiments use a single-axis accelerometer, which measure the acceleration of the mobile computing device in a single direction. Other embodiments use a multi-axis, such as a three-axis, accelerometer that measures the acceleration of the mobile computing device 110 in many directions (e.g. x-, y-, and z-axis). Embodiments of the accelerometer use a micro electro-mechanical system (MEMS), where the deflection of a small cantilever beam, attached to a proof mass, is measured to determine the acceleration. Other embodiments may use a piezoelectric, piezoresistive, and/or capacitive component to convert a mechanical motion into an electrical signal.

The gyroscope 330 is configured to measure the orientation of the mobile computing device 110. Some embodiments may use a single-, two-, or three-axis gyroscope to measure the pitch, roll, and/or yaw of the mobile computing device 110. In some embodiments the accelerometer and gyroscope is replaced by a six-axis sensor that includes a three-axis accelerometer and a three-axis gyroscope in a single sensing element.

The ambient light sensor 330 detects the amount of light there is in the surroundings of the mobile computing device 110. The ambient light sensor 330 can be implemented as a reversed biased light emitting diode (LED), a photodiode, a photoresistor, a charge-coupled device (CCD), etc. Some embodiments of the mobile computing device 110, for example, use the ambient light sensor 330 to adjust the brightness of the screen 130. Other embodiments may also use the ambient light sensor 330 to determine whether to turn on a back light for the keypad 150.

### Transmission of Physical Representations

FIG. 3B contains a high level block diagram illustrating a detailed view of modules within the physical representation transmission module 228 according to one embodiment. Some embodiments of the physical representation transmission module 228 have different and/or other modules than the ones described herein. Similarly, the functions can be distributed among the modules in accordance with other embodiments in a different manner than is described here. Likewise, the functions can be performed by other entities. The physical representation transmission module 228 includes modules for performing various functions. These modules include a physical action sensing module 360, a transmission module 370, and a physical representation simulation module 380.

The physical action sensing module 360 determines if a user is has performed a certain physical action, such as hugging the mobile computing device 110. The physical action sensing module 360 utilizes different sensors such as the proximity sensor 310. For example, in one embodiment, in order to determine if a user has hugged the mobile computing device 110, the physical action sensing module 360 uses the proximity sensor 310 to detect the presence of a large object, e.g., a person's chest. Furthermore, the physical sensing module 360 may also use the accelerometer 320 and/or the gyroscope 330 to determine if the mobile computing device 110 is in the upright position to determine whether the mobile computing device 110 has been hugged. Other embodiments may use another sensor, such as a capacitive touch sensor, a pressure sensor, an image capture device (e.g. a camera), an audio capture device (e.g., a microphone) and the like.

Some embodiments of the physical action sensing module 360 allow the connection of an external sensing device to determine whether a physical action has been performed. For example, a heart rate monitor may be connected to the mobile computing device 110 to supplement the sensors already included in the mobile computing device 110.

The transmission module 370 sends instructions to a second mobile computing device 110 via the transceiver 264. In one embodiment, both computing devices know all the steps needed to send and receive a physical representation. In one exemplary embodiment the transmission module 370 only needs to send a signal identifying which physical representation is being sent. In another embodiment, the transmission module 370 sends the mobile device receiving the physical representation instructions on how to successfully complete the physical representation. The transmission module 370 is also responsible of sending a request to perform a certain action and sending an acknowledgment that the action has been performed successfully. For example, if a first user wants to send a hug to a second user, the transmission module 370 from the first user's mobile computing device 110 sends a signal to the second user's mobile computing device 110 requesting the second user to hug the second user's mobile computing device 110. After the second user hugs the second user's mobile computing device 110, the transmission module 370 form the second user's mobile computing device 110 sends a signal indicating that the action has been performed.

In some embodiment, the transmission module first sends a signal to a server and the server routes the signal to the second user's mobile device. The server can then maintain a log of all the actions performed by both users. In other embodiments, the transmission module directly sends all signals to the other user's mobile device.

The physical representation simulation module 380 simulates the physical representation being sent. The physical representation simulation module 380 may use different components to simulate different physical representations. For example the vibration motor 206 can be used to simulate a hug. After a user has hugged a mobile computing device 110 against his chest, the physical representation simulation module 380 can use the vibration motor 206 to simulate the feeling of a hug. Other embodiments may use different components such as the speaker 120, or the screen 130. Some embodiments may also allow the connection of external components, not included in the mobile computing device 110, to simulate physical representations. For example, an external device may be connected using the short-range radio 218 (e.g. a Bluetooth device), an auxiliary output jack, or a universal serial bus (USB) port.

In some embodiments, the way the physical representation simulation module 380 simulates a physical representation is pre-configured. In other embodiments, the user sending the physical representation can customize the physical representation being sent. For example, the amount of time and intensity of the vibration provided by the vibration motor can be specified by the user sending a hug and sent to the user receiving the hug.

In some embodiments, each physical representation is associated to a unique physical representation simulation sequence. For example, a hug may be associated to a single long vibration (e.g., 5 seconds vibration); a kiss may be associated to a single short vibration (e.g., half second vibration); a hand shake may be associated to two short vibrations.

In some embodiments the transmitted physical representation simulation sequence is controlled by the physical action performed by either the user sending the physical representation, or the user receiving the physical representation. For example, when a user wants to transmit a hug, both, the sending user and the receiving user, are requested to perform the physical action (i.e., both users are requested to hug their respective mobile computing device 110). When both users are performing the physical action, both mobile computing devices 110 start vibrating until one of the users ends the physical action (i.e., one of the users stop hugging his mobile computing device 110).

In one embodiment, a more complex sequence can be performed to simulate a physical action. For example, if a user wants to send a handshake, both users are requested to hold their respective mobile computing device 110 with their right hand. When both users are holding their respective mobile computing device 110, every time one of the users move his hand up or down, the other mobile computing device 110 vibrates. In one embodiment, the intensity and the duration of each vibration are controlled by the acceleration sensed by the sensing module 208 (e.g., sensed by the accelerometer 320).

In addition, in some embodiments the above configurations may be further augmented with data from one or more physiological sensors that may be in the device. These can measure different parameters such as blood flow, temperature, pressure modality, etc. to provide a physiological analysis that can be mapped to a response. For example, a high heart rate and increase in body temperature along with longer length of time may correspond to an excitement hug while lower heart rate and less pressure applied and a shorter length of time may correspond with a condolence hug. These mapping of actions and data may be stored in a database.

FIG. 4A and FIG. 4B are flowcharts describing different embodiments of a process for the transmission of physical representations. In one embodiment, the physical representation transmission module 228 receives 401 a request, from a first user, to send a physical representation, to a second user. The physical representation transmission module 228 requests the first user to perform a physical action, such as hugging the mobile computing device 110a. Thereafter, the transmission module 370 transmits 405 a physical representation signal to a second user's mobile computing device 110b. The second user's mobile computing device 110b receives 407 the physical representation signal. Subsequently, the second user's mobile computing device's physical representation transmission module 228 may optionally request 409 the second user to perform a physical action, such as hugging the mobile computing device 110b. After the second user performs the physical action and the second user's physical action sensing module 360 senses 411 the physical action, the second user's physical representation simulation module 380 simulates 417 the physical representation. Additionally, in some embodiments, after the second user's physical action sensing module 360 senses 411 the physical action, the second user's transmission module 370 sends 413 a confirmation that the physical action has been performed by the second user. The first user's mobile computing device 110a then receives 415 the confirmation that the physical action has been performed by the second user. Finally the first user's physical representation simulation module 380 concurrently simulates 417 the physical representation.

In some embodiments, if the second user does not perform the physical representation within a predetermined amount of time, the physical representation times out. In other embodiments, the second user can decline the physical representation. The second user may additionally send another physical representation (e.g. a push back) in response to the physical representation sent by the first user. In yet other embodiments, the second user can save the physical representation to be executed at a later time. Embodiments of the physical representation transmission module 228 can inform the first user of the decision of the second user (e.g. second user declining the physical representation, or second user saving the physical representation for later).

### Additional Configuration Considerations

The embodiments described herein beneficially allow mobile computing devices to transmit non-verbal communications. More specifically, by utilizing components present in a mobile computing device, embodiments will allow users to transmit, in real-time, physical representations such as hugs, kisses, high-fives, etc.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for transmitting a physical representation from one location to another location through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method comprising:
transmitting, from a first computing device to a second computing device, a request to send a physical representation;
receiving, by the second computing device, the request to send a physical representation;
requesting a user using the second computing device to perform a physical action;
detecting that the user using the second device has performed the physical action; and
responsive to detecting that the user using the second computing device has performed the physical action, transmitting to the second computing device the physical representation simulating the physical action.

2. The method of claim 1, wherein the physical representation is a hug.

3. The method of claim 2, wherein the physical action is to hug the second computing device.

4. The method of claim 3, wherein the detecting comprises detecting, using a proximity sensor, a large object.

5. The method of claim 4, wherein the detecting further comprises determining, using one of an accelerometer and a gyroscope, that the computing device is in the upright position.

6. The method of claim 1, wherein the transmitting to the second computing device the physical representation simulating the physical action comprises using a vibrating motor to vibrate the second computing device.

7. The method of claim 1, further comprising:
requesting a user using the first computing device to perform the physical action;
detecting that the user using the first device has performed the physical action; and
responsive to detecting that the user using the first computing device and the user using the second computing device has performed the physical action, simulate, by the first computing device, the physical representation.

8. A system for transmitting a physical representation from a first computing device to a second computing device comprising:
a transmission module configured to transmit a request to send a physical representation;
a physical action sensing module configured to detect that a user has performed a physical action; and
a physical representation simulation module configured to simulate the physical representation responsive to the detection of the physical action by the physical action sensing module.

9. The system of claim 8, wherein the physical representation is a hug.

10. The system of claim 9, wherein the physical action is to hug the second computing device.

11. The system of claim 10, wherein detecting that a user has performed a physical action comprises detecting, using a proximity sensor, a large object.

12. The system of claim 11, wherein the detecting further comprises determining, using one of an accelerometer and a gyroscope, that the computing device is in the upright position.

13. The system of claim 8, wherein the simulate the physical representation comprises using a vibrating motor to vibrate the second computing device.

14. A computer-readable storage medium configured to store instructions for transmitting a physical representation from a first computing device to a second computing device comprising:
a transmission module configured to transmit a request to send a physical representation;
a physical action sensing module configured to detect that a user has performed a physical action; and
a physical representation simulation module configured to simulate the physical representation responsive to the detection of the physical action by the physical action sensing module.

15. The system of claim 14, wherein the physical representation is a hug.

16. The system of claim 15, wherein the physical action is to hug the second computing device.

17. The system of claim 16, wherein detecting that a user has performed a physical action comprises detecting, using a proximity sensor, a large object.

18. The system of claim 17, wherein the detecting further comprises determining, using one of an accelerometer and a gyroscope, that the computing device is in the upright position.

19. The system of claim 14, wherein the simulate the physical representation comprises using a vibrating motor to vibrate the second computing device.
